(19) United States
(12) Patent Application Publication
(10) Pub. No.: US 2026/0151892 A1
(43) Pub. Date: Jun. 4, 2026

(54) BUCKET HOOK

(71) Applicant: Anthony Weikert, West Milton, OH (US)

(72) Inventor: Anthony Weikert, West Milton, OH (US)

(21) Appl. No.: 18/249,705

(22) PCT Filed: Oct. 21, 2021
(86) PCT No.: PCT/US2021/055972

§ 371 Date: Apr. 19, 2023

Related U.S. Application Data
(63) Continuation of application No. 29/801,274, filed on Jul. 28, 2021, now Pat. No. D1018263.
(60) Provisional application No. 63/094,405, filed on Oct. 21, 2020.
(60) Provisional application No. 63/153,343, filed on Feb. 24, 2021.

(51) Int. Cl. B25H 3/00; F16B 45/00; H02G 1/02

(52) U.S. Cl. CPC B25H 3/00; F16B 45/00; F16B 2200/83; H02G 1/02

(57) ABSTRACT

A bucket hook assembly that has an upper base section, a back hook assembly extending from the upper base section and defining a back hook, and a front hook assembly extending from the upper base section and defining a first and second front hook. In this embodiment both the first and second hook extend from the same front hook base. Further, the bucket hook assembly is configured to be positionable along an edge of a bucket to provide tool and material storage on the back hook, first front hook, and second front hook.

### CROSS-REFERENCE TO RELATED DISCLOSURES

The present disclosure is a U.S. National Phase Entry of International Application No. PCT/US21/55972 filed Oct. 21, 2021 and claims the benefit of U.S. Design application Ser. No. 29/801,274 filed on Jul. 28, 2021, U.S. Provisional Application No. 63/153,343 filed on Feb. 24, 2021, and U.S. Provisional Application No. 63/094,405 filed on Oct. 21, 2020, the contents of which are incorporated herein by reference in entirety.

### FIELD OF THE DISCLOSURE

The present disclosure relates generally to a hook, and more specifically to a hook sized to fit over an edge of a bucket of a bucket truck to hold tools and materials for a lineman.

### BACKGROUND

Lineman often have to access elevated power lines and the like from a bucket on a boom from a bucket truck. Typically, the lineman must put their tools and other materials in the bucket or hang them from a single bucket hook on the tope edge of the bucket. This results in the interior of the bucket being crowded and disorganized or requires multiple trips from the elevated lines to the ground to obtain new tools or materials. There is a need for a bucket hook that provides a plurality of coupling options to assist the lineman in quickly and efficiently working.

### SUMMARY

One embodiment is a bucket hook assembly that has an upper base section, a back hook assembly extending from the upper base section and defining a back hook, and a front hook assembly extending from the upper base section and defining a first and second front hook. In this embodiment both the first and second hook extend from the same front hook base. Further, the bucket hook assembly is configured to be positionable along an edge of a bucket to provide tool and material storage on the back hook, first front hook, and second front hook.

One example of this embodiment includes a coupling orifice defined at least partially between the first and second hook. Another example of this embodiment includes a cotter key holder defined in the upper base and configured to partially receive a cotter key. Yet another example of this embodiment includes a recessed portion in the upper base section, wherein the recessed portion has a raised perimeter configured to inhibit tools or materials from falling out of the recessed portion. Yet another example has a magnet coupled to the upper section along a top surface, the magnet configured to selectively retain magnetizable tools and parts placed along the upper base. Another example has a recessed portion in the upper base section and a magnet coupled to the upper base section along the recessed portion, wherein the recessed portion has a raised perimeter configured to inhibit tools or materials from falling out of the recessed portion and the magnet is configured to selectively retain magnetizable tools and parts placed along the recessed portion.

Another example of this embodiment has at least a first bend in the front hook base between the upper base section and the first and second front hook. One part of this example includes a second bend in the front hook base between the upper base section and the first and second front hook. In this part, the at least first bend and second bend in the front hook base are sized to substantially follow the profile of an exterior surface of a bucket.

In yet another example of this embodiment, the back hook assembly further comprises a first and second back hook wherein both the first and second back hook extend from the same back hook base. Part of this example includes a coupling orifice defined at least partially between the first and second back hook. In this part, the back hook base extends substantially linearly from the upper base section.

Yet another embodiment of this disclosure is a bucket hook assembly that has a base section having an upper section configured to hold tools and parts, a front hook assembly having a front hook base extending from the base section and splitting to define both a first front hook and a second front hook, and a back hook assembly having a back hook base extending from the base section and splitting to define both a first back hook and a second back hook. The front hook assembly and back hook assembly are spaced from one another to allow a portion of a bucket to be positioned therebetween with the front hook assembly positioned along an exterior portion of the bucket and the back hook assembly positioned along an interior portion of the bucket.

One example of this embodiment has a front coupling orifice defined at least partially between the first and second front hook and a back coupling orifice defined at least partially between the first and second back hook. One part of this example has a cotter key holder defined in the upper base and configured to partially receive a cotter key.

Another example of this embodiment has a recessed portion in the upper base section, wherein the recessed portion has a raised perimeter configured to inhibit tools or materials from falling out of the recessed portion. Part of this example has a magnet coupled to the upper section along a top surface, the magnet configured to selectively retain magnetizable tools and parts placed along the upper base.

Yet another example of this embodiment has a first bend and a second bend in the front hook base between the upper base section and the first and second front hook. In one part of this example, the back hook base extends substantially linearly from the upper base section.

Yet another embodiment of this disclosure is a method for manufacturing a bucket hook assembly. The method includes injecting a molten material into mold, the mold defining at least part of a base section having an upper section configured to hold tools and parts, a front hook assembly having a front hook base extending from the base section and splitting to define both a first front hook and a second front hook, and a back hook assembly having a back hook base extending from the base section and splitting to define both a first back hook and a second back hook and allowing the molten material to cool into a solid material.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a top perspective view of a bucket hook;

FIG. 2 is a side view of the bucket hook of FIG. 1;

FIG. 3 is another side view of the bucket hook of FIG. 1;

FIG. 4 is a back view of the bucket hook of FIG. 1;

FIG. 5 is a front view of the bucket hook of FIG. 1;

FIG. 6 is a top view of the bucket hook of FIG. 1;

FIG. 7 is a bottom view of the bucket hook of FIG. 1;

FIG. 8 is an elevated perspective view of another embodiment of a bucket hook;

FIG. 9 is a side view of the bucket hook of FIG. 8;

FIG. 10 is a bottom view of the bucket hook of FIG. 8; and

FIG. 11 is a flowchart of the method of manufacturing a bucket hook assembly.

Corresponding reference numerals are used to indicate corresponding parts throughout the several views.

### DETAILED DESCRIPTION

For the purposes of promoting an understanding of the principles of the present disclosure, reference will now be made to the embodiments described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

The bucket hook assembly 100 may have an upper base section 102 that is substantially planar and that may have a magnet 122 therein. The upper base section 102 may have a recessed portion 118 with a raised perimeter 120 configured to inhibit tools, parts, or materials from falling out of the recessed portion 118. The upper base section 102 may have a magnet 122 in it configured to receive and retain tools and parts wherein magnetic parts are affected by the magnetic force of the magnet 122 to resist falling out of the upper base section 102. The magnet 122 may be coupled to the upper base section 102 along the recessed portion 118. The magnet 122 may be coupled to the recessed portion 118 in a cavity sized to correspond with the dimensions of the magnet 122. Alternatively, the magnet 122 may be formed into the recessed portion 118 during the molding process. Further still, the magnet 122 may be coupled to the top surface of the recessed portion 118.

The bucket hook assembly 100 may have a front and back hook assembly 104, 108. The front and a back hook assemblies 104, 108 may each extend from a lower surface of the base section 102. The bucket hook assembly 100 may be sized to fit over an upper lip of a bucket 200 to provide the user coupling options for tools, parts, and materials as discussed herein. More specifically, the front hook assembly 108 may be configured to be positioned along an outer side of the bucket 200 and the back hook assembly 104 may be configured to be positioned on the inner side of the bucket 200. The bucket hook assembly 100 may be configured to be positionable along an edge of the bucket 200 to provide tool and material storage on the back hook 106, first front hook 110, second front hook 112, and a coupling orifice 116. The front hook assembly 108 may extend down from the bottom of the upper base section 102 along a front hook base 114 until the front hook 114 base is split to form the first front hook 110 and the second front hook 112.

The front hook base 114 may have at least a first bend 124 and a second bend 126 between the upper base section 102 and the first and second front hook 110, 112. The first bend 124 and second bend 126 in the front hook base 114 may be sized to substantially follow the profile of the exterior surface of the bucket 200. In other words, the bends 124, 126 may provide a cavity 202 where the lip of the bucket 200 may be positioned when the bucket hook assembly 100 is properly positioned over the bucket 200 while also defining a pinch point 204 between the front and back hook assemblies 104, 108. In this configuration, the front and back hook assemblies 104, 108 may be elastically deformed to allow the lip of the bucket 200 to pass through the pinch point 204 and into the cavity 202. Once positioned therein, the pinch point 204 may return to the unstressed state and position the front and back hook assemblies 104, 108 on opposing sides of the bucket 200 to substantially prevent the bucket hook assembly 100 from falling off the bucket 200.

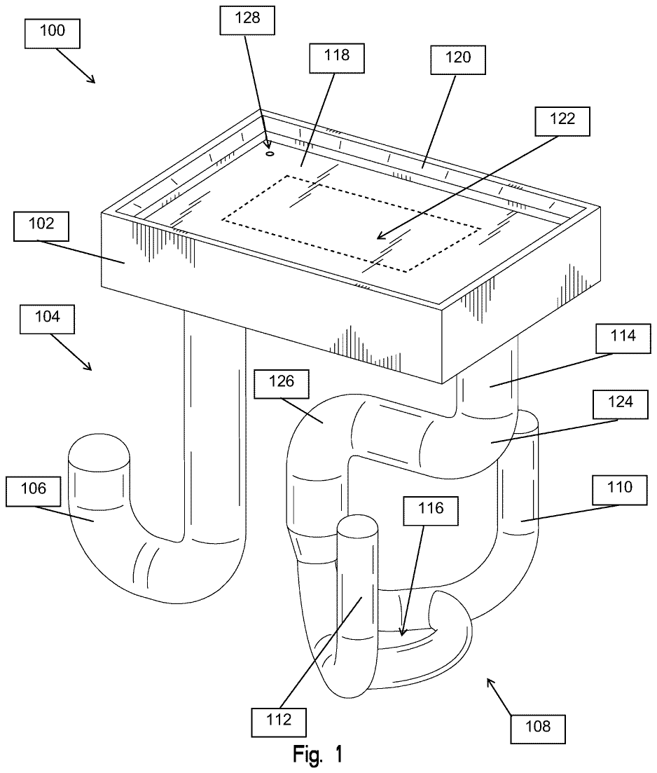

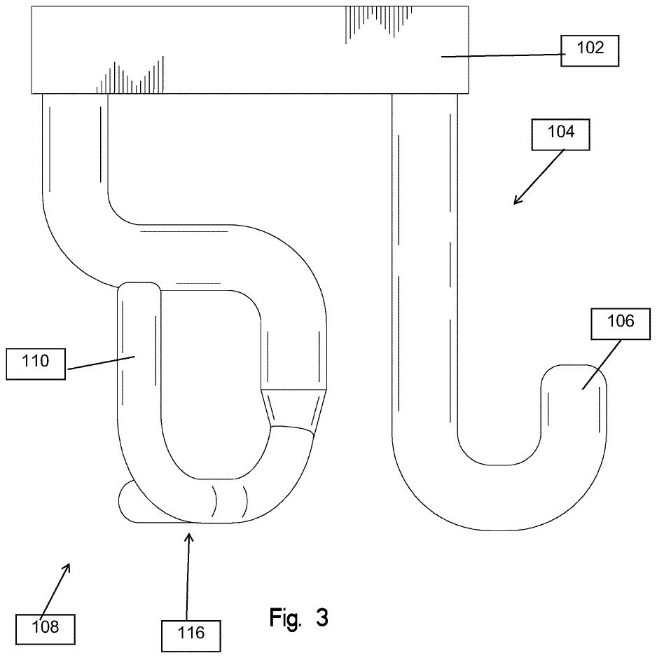

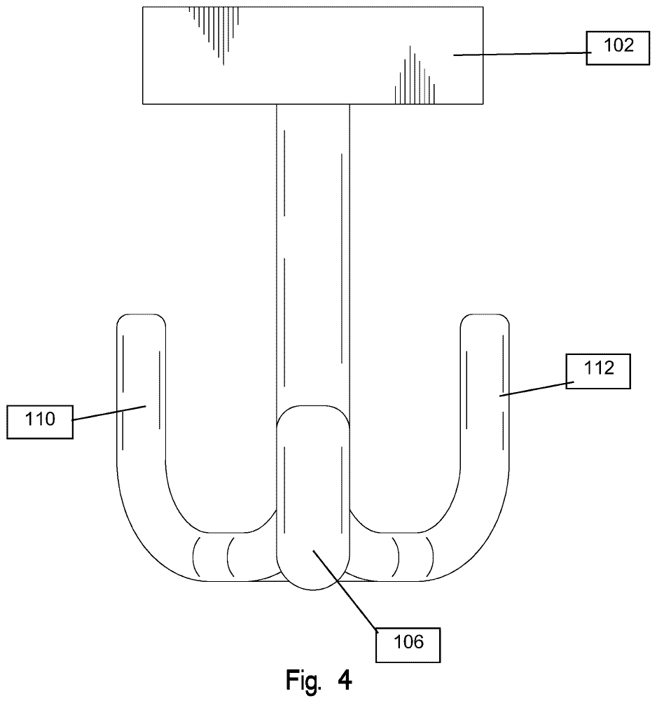

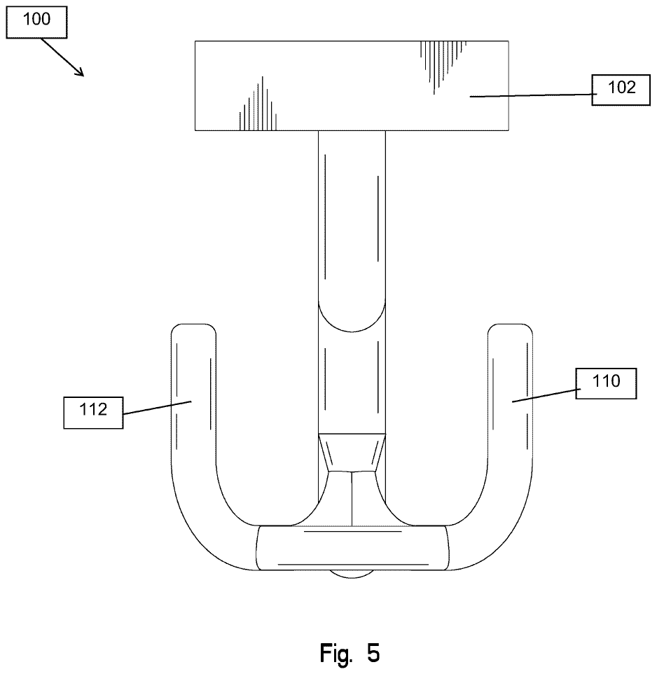

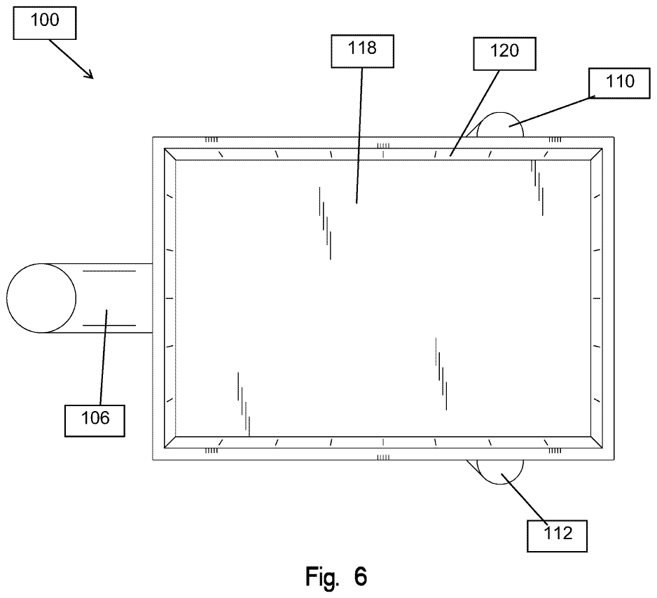

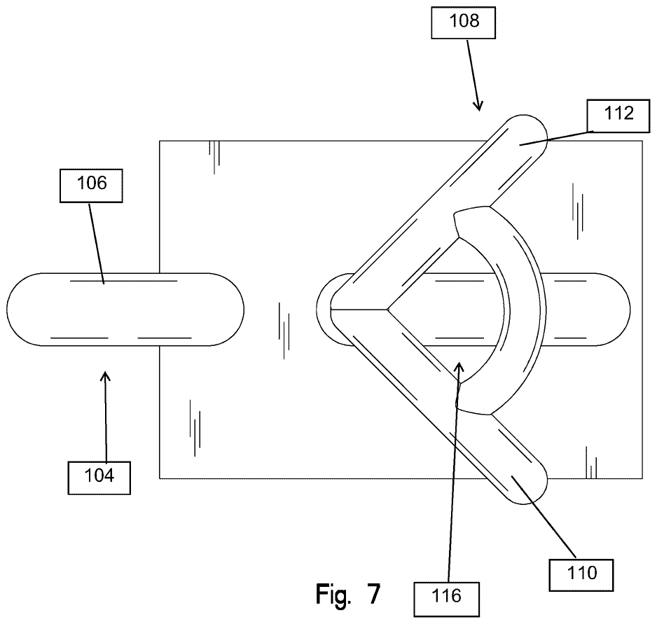

Along the location where the separate hooks 110, 112 separate from each other, at least partially between the first and second hook 110, 112, a coupling orifice 116 such as a hole may be defined. The coupling orifice 116 may provide a location for a carabineer or other clip to be coupled to the bucket hook assembly 100. In the embodiment of FIGS. 1-7, the back hook assembly 104 may extend substantially directly down from the upper base section 102 before defining a back hook 106. The single back hook 106 may provide a location for a tool board or the like to be coupled to the back hook 106 among other things.

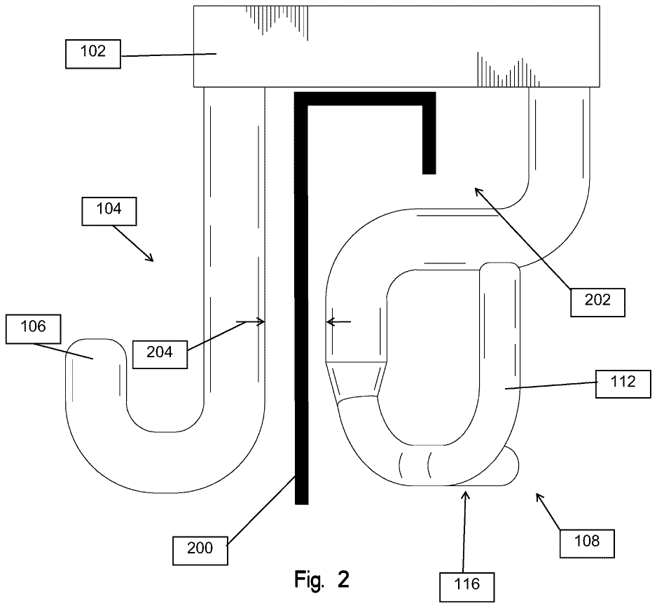

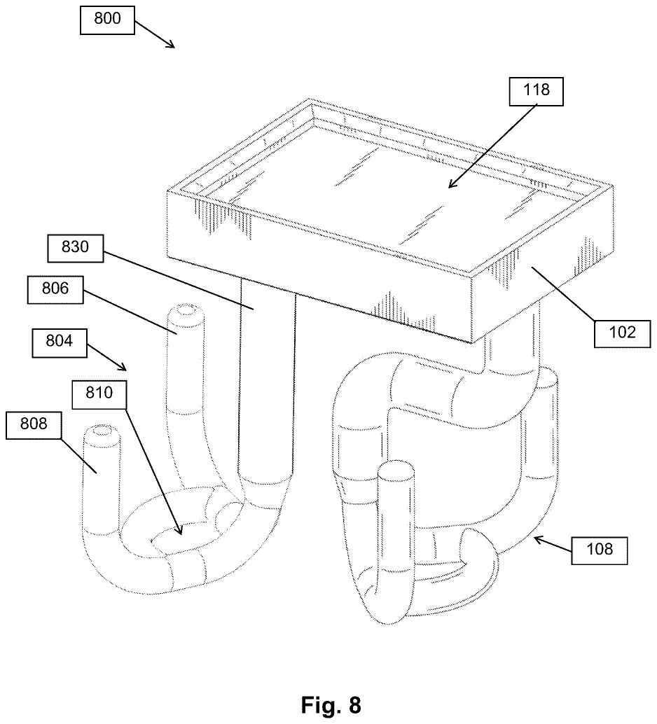

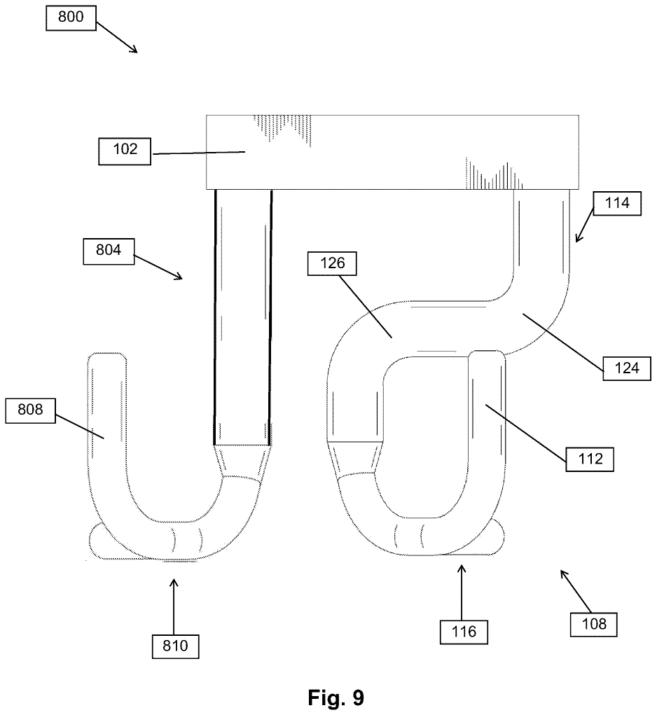

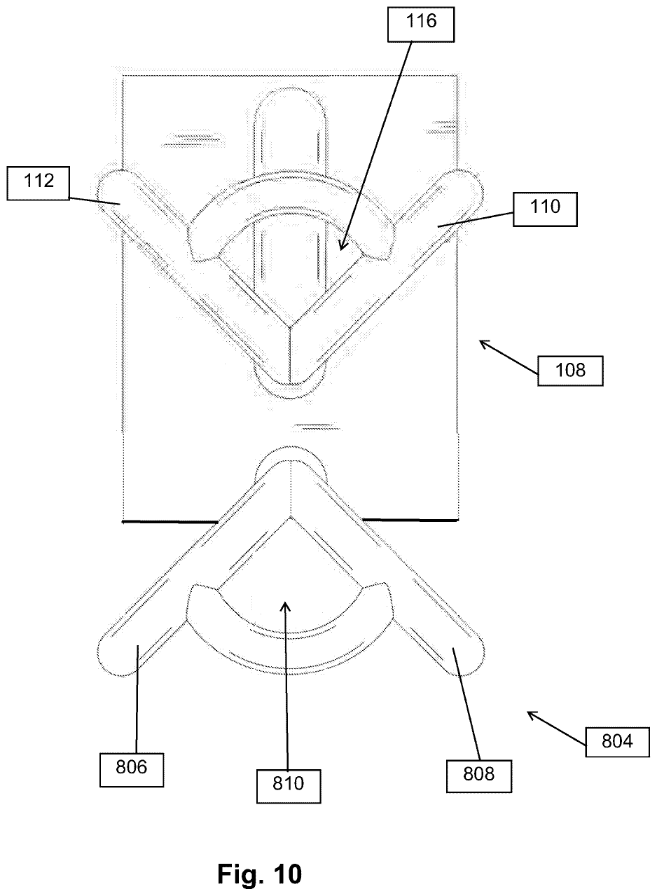

Another embodiment of a bucket hook assembly 800 is illustrated in FIGS. 8-10. In this embodiment, an alternative back hook assembly 804 may have both a first back hook 806 and a second back hook 808 while the front hook assembly 108 maintains the first and second front hook 110, 112 as described herein. This back hook assembly 804 may extend down substantially linearly from the bottom of the upper base section 102 along a back hook base 830 until the back hook base 830 is split to form the first back hook 806 and the second back hook 808. Further, back coupling orifice 810 or hole may be defined between the separation of the two separate hooks 806, 808 at the back hook assembly 804 similar to the coupling orifice 116 discussed herein for the front hook assembly 108. In this embodiment, the front hook assembly 108 and back hook assembly 804 may be spaced from one another to allow a portion of the bucket 200 to be positioned therebetween with the front hook assembly 108 positioned along an exterior portion of the bucket 200 and the back hook assembly 804 positioned along an interior portion of the bucket 200 as discussed herein with reference to FIG. 2. In the embodiment of FIGS. 8-10, the bucket hook assembly 800 may also have the recessed portion 118 in the upper base section 102 configured to prevent tools or materials from falling out of the recessed portion 118. Similar to the embodiment with one back hook 106, this embodiment may have a magnet coupled to the upper section configured to magnetically retain tools and parts placed along the upper base section 102. In this embodiment, the bucket hook assembly 800 may still have the one or more first bends 124 and one or more second bends 126 in the front hook base 114 between the upper base section 102 and the first and second front hook 110, 112.

Any of the embodiments discussed herein may have a cotter key holder 128 defined in the base 102 as illustrated in FIG. 1. More specifically, the upper section of the base 102 may have a slightly recessed portion 118 intended to hold parts therein. The cotter key holder 128 may be a partial through hole in the base section 102 sized to position a cotter key therein to provide easy access for the lineman.

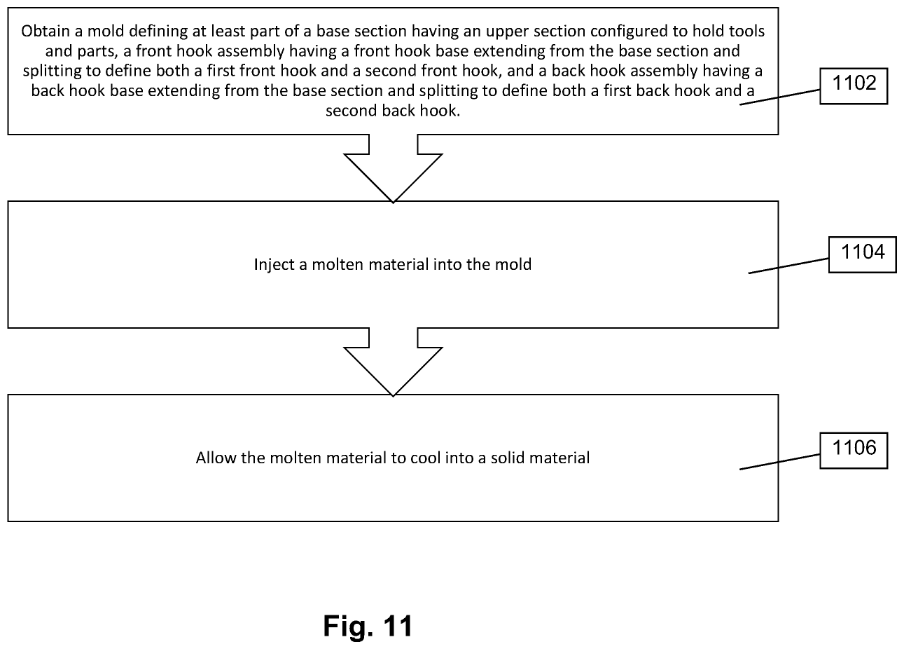

As illustrated in FIG. 11, one method of manufacturing the bucket hook assembly 100 or 800 may include providing a mold as in box 1102. The mold may define at least part of a base section having an upper section 102 configured to hold tools and parts, a front hook assembly 108 having a front hook base 114 extending from the base section and splitting to define both a first front hook 110 and a second front hook 112, and a back hook assembly 204 having a back hook base 130 extending from the base section and splitting to define both a first back hook 206 and a second back hook 208. In other words, the mold may have corresponding features to form the bucket hook assembly 100 or 800 described herein. In box 1104, molten material may be injected into the mold. Finally, in box 1106, the molten material is cooled into a solid material and then removed from the mold.

The bucket hook assembly 100, 800 may be formed of a plastic, metal, rubber, or the like material. In one aspect of this disclosure, the bucket hook assembly 100, 800 is formed of a material with such material properties that the corresponding hook assemblies 104, 108 can elastically deformed to expand the 204 pinch point to allow the lip of the bucket 200 to be positioned within the cavity 202 without breaking the hooks assemblies 104, 108 from the base section 102. Further, the material may have sufficient stiffness so the hook assembly 100, 800 cannot be easily knocked from the bucket 200.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A bucket hook assembly, comprising:
an upper base section;
a back hook assembly extending from the upper base section and defining a back hook; and
a front hook assembly extending from the upper base section and defining a first and second front hook, wherein both the first and second hook extend from the same front hook base;
wherein, the bucket hook assembly is configured to be positionable along an edge of a bucket to provide tool and material storage on the back hook, first front hook, and second front hook.

2. The bucket hook assembly of claim 1, further comprising a coupling orifice defined at least partially between the first and second hook.

3. The bucket hook assembly of claim 1, further comprising a cotter key holder defined in the upper base and configured to partially receive a cotter key.

4. The bucket hook assembly of claim 1, further comprising a recessed portion in the upper base section, wherein the recessed portion has a raised perimeter configured to inhibit tools or materials from falling out of the recessed portion.

5. The bucket hook assembly of claim 1, further comprising a magnet coupled to the upper base section along a top surface, the magnet configured to selectively retain magnetizable tools and parts placed along the upper base.

6. The bucket hook assembly of claim 1, further comprising a recessed portion in the upper base section and a magnet coupled to the upper section along the recessed portion, wherein the recessed portion has a raised perimeter configured to inhibit tools or materials from falling out of the recessed portion and the magnet is configured to selectively retain magnetizable tools and parts placed along the recessed portion.

7. The bucket hook assembly of claim 1, further comprising at least a first bend in the front hook base between the upper base section and the first and second front hook.

8. The bucket hook assembly of claim 7, further comprising a second bend in the front hook base between the upper base section and the first and second front hook.

9. The bucket hook assembly of clam 8, wherein the at least first bend and second bend in the front hook base are sized to substantially follow the profile of an exterior surface of a bucket.

10. The bucket hook assembly of claim 1, further wherein the back hook assembly further comprises a first and second back hook wherein both the first and second back hook extend from the same back hook base.

11. The bucket hook assembly of claim 10, further comprising a coupling orifice defined at least partially between the first and second back hook.

12. The bucket hook assembly of claim 11, wherein the back hook base extends substantially linearly from the upper base section.

13. A bucket hook assembly, comprising:
a base section having an upper section configured to hold tools and parts;
a front hook assembly having a front hook base extending from the base section and splitting to define both a first front hook and a second front hook; and
a back hook assembly having a back hook base extending from the base section and splitting to define both a first back hook and a second back hook;
wherein, the front hook assembly and back hook assembly are spaced from one another to allow a portion of a bucket to be positioned therebetween with the front hook assembly positioned along an exterior portion of the bucket and the back hook assembly positioned along an interior portion of the bucket.

14. The bucket hook assembly of claim 13, further comprising a front coupling orifice defined at least partially between the first and second front hook and a back coupling orifice defined at least partially between the first and second back hook.

15. The bucket hook assembly of claim 14, further comprising a cotter key holder defined in the upper base and configured to partially receive a cotter key.

16. The bucket hook assembly of claim 13, further comprising a recessed portion in the upper base section, wherein the recessed portion has a raised perimeter configured to inhibit tools or materials from falling out of the recessed portion.

17. The bucket hook assembly of claim 16, further comprising a magnet coupled to the upper section along a top surface, the magnet configured to selectively retain magnetizable tools and parts placed along the upper base.

18. The bucket hook assembly of claim 13, further comprising a first bend and a second bend in the front hook base between the upper base section and the first and second front hook.

19. The bucket hook assembly of claim 18, wherein the back hook base extends substantially linearly from the upper base section.

20. A method for manufacturing a bucket hook assembly, comprising:
injecting a molten material into mold, the mold defining at least part of a base section having an upper section configured to hold tools and parts, a front hook assembly having a front hook base extending from the base section and splitting to define both a first front hook and a second front hook, and a back hook assembly having a back hook base extending from the base section and splitting to define both a first back hook and a second back hook; and
allowing the molten material to cool into a solid material.
